(19) United States
(12) Patent Application Publication
(10) Pub. No.: US 2012/0099526 A1
(43) Pub. Date: Apr. 26, 2012

(54) DECODING DEVICE

(75) Inventor: Taichi MURASE, Kawasaki (JP)

(73) Assignee: FUJITSU LIMITED, Kawasaki-shi (JP)

(21) Appl. No.: 13/178,141

(22) Filed: Jul. 7, 2011

(30) Foreign Application Priority Data
Oct. 20, 2010 (JP) 2010-235769

(51) Int. Cl. H04W 4/18

(52) U.S. Cl. 370/328

(57) ABSTRACT

A decoding device includes a decoder that conducts decoding on transmission data sent a predetermined number of transmissions from respective communication partners; and a scheduler that identifies transmission data to be decoded by the decoder at a certain decoding timing among decoding timings that occur periodically and that determines whether to decode the identified transmission data at the certain decoding timing, based on a number of transmissions in which the identified transmission data has been sent.

### CROSS-REFERENCE TO RELATED APPLICATIONS

This application is based upon and claims the benefit of priority of the prior Japanese Patent Application No. 2010-235769, filed on Oct. 20, 2010, the entire contents of which are incorporated herein by reference.

### FIELD

The embodiments discussed herein are related to a decoding device that receives transmission data transmitted a certain number of times and conducts decoding on the transmitted data for the same encoded data.

### BACKGROUND

Transmission Time Interval (TTI) Bundling in UL-SCH (Uplink Sheared Channel) HARQ (Hybrid Automatic Repeat Request) control is prescribed in LTE (Long Term Evolution) which is standardized by the 3rd Generation Partnership Project (3GPP). HARQ is an error recovery technology that holds incorrect data and combines the incorrect data with retransmitted data. TTI Bundling is technique in HARQ control wherein a sending side repeatedly sends retransmission data a prescribed number of times without waiting for ACK/NACK responses, while a receiving side sends ACK/NACK responses in response to a decoding result of the data received the prescribed number of times.

Initial transmission and retransmission data, whose number is prescribed as a TTI_BUNDLE_SIZE, are repeatedly sent without using feedback commands from a base station in TTI Bundling. The HARQ control handles multiple subframe blocks of data prescribed by the TTI_BUNDLE_SIZE as one block instead of handling each subframe. Subframe blocks of initial and retransmission data prescribed by the TTI_BUNDLE_SIZE as one block are referred to as TTI_BUNDLE data. In non-patent literature 1, the TTI_BUNDLE_SIZE is four.

FIG. 2 is a sequence diagram illustrating messages transmitted between a mobile station (User Equipment: UE) and a base station when TTI Bundling is applied. In FIG. 2, the UE sends data (UL-SCH) to the base station. UL-SCH transmission from an initial transmission UL-SCH(0-0) to a retransmission UL-SCH(0-3) is performed without feedback commands being received from the base station. On the other hand, the base station sends an ACK command when the decoding result of one TTI_BUNDLE data is acceptable (OK), and a NACK command when not acceptable (NG) as a feedback command. In this way, HARQ control of each TTI_BUNDLE data is performed.

FIGS. 2, 3, and 4 describe UL-SCH decoding processing when TTI Bundling is applied in a communication device. The communication device illustrated in FIG. 1 is equipped with a transmission antenna 2-1, a radio frequency (RF) unit 2-2, a demodulator 2-3, a channel decoder 2-4, a HARQ buffer 2-5, a turbo decoder 2-6, and a scheduler 2-7.

Uplink data (radio signals) received from the UE via the transmission antenna 2-1 is processed by the RF unit 2-2 to be converted into baseband signals. The scheduler 2-7 manages UE assignment information, modulation systems, and other information required for demodulation and decoding, and sends scheduling information to the demodulator 2-3 and the channel decoder 2-4. Baseband signals are demodulated by the demodulator 2-3 and the demodulated data is channel-decoded by the channel decoder 2-4. If the received data is the retransmission data, the channel decoder 2-4 combines retransmission data with the previously received data stored in the HARQ buffer 2-5 to improve decoding characteristics.

The channel-decoded data is sent to the turbo decoder 2-6. The turbo decoder 2-6 conducts turbo-decoding on the convolutional encoded data (channel-decoded data) and conducts a cyclic redundancy check (CRC) on the data. If the CRC evaluation result is acceptable (OK), an ACK command is sent to the UE. On the other hand, if the evaluation result is unacceptable (NG), a NACK command is sent. As described above, a feedback command is sent only once for each TTI Bundle data block (4 subframes) when TTI Bundling is applied.

If the CRC evaluation results of the first to third transmissions of the received signals are OK, the turbo decoder 2-6 stops decoding since there is no need to decode the subsequent data. FIG. 3 is an exemplary sequence diagram in which the CRC evaluation result of the second decoding is OK. As a result, the third and fourth decodings are not conducted. Unnecessary decoding can be avoided and energy consumption reduced due to this type of HARQ control.

FIG. 4 is a flow chart of the abovementioned decoding process. A base station receives UL-SCH in each subframe (S-1), and then subsequently conducts demodulation (S-2), channel-decoding (S-3), turbo-decoding (S-4), and CRC evaluation (S-5). If the CRC evaluation result in step S-5 is OK, the feedback command (ACK) is sent to the UE at a prescribed timing (S-6). If an acceptable CRC evaluation result is obtained from any one of the first transmission to third data transmission, the subsequent retransmission data is not received as described above.

Conversely, if the CRC evaluation result is NG, the number of transmitted data of interest is checked (S-7) and UL-SCH receiving processing on the next subframe is conducted if the transmission in question is the first to third transmission. However, if the transmission is the fourth transmission, the feedback command (NACK) is sent at a prescribed timing (S-8) since the applicable TTI BUNDLE data will not be sent from the UE.

### SUMMARY

According to an aspect of the embodiment, a decoding device includes a decoder that conducts decoding on transmission data sent a predetermined number of transmissions from respective communication partners; and a scheduler that identifies transmission data to be decoded by the decoder at a certain decoding timing among decoding timings that occur periodically and that determines whether to decode the identified transmission data at the certain decoding timing, based on a number of transmissions in which the identified transmission data has been sent.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 illustrates an exemplary configuration of a receiving device conducting TTI Bundling.

FIG. 2 is a sequence diagram illustrating operations between a UE and a base station when TTI Bundling is applied.

FIG. 3 is a sequence diagram illustrating base station operations with TTI Bundling.

FIG. 4 is a flowchart illustrating base station operations with TTI Bundling.

FIG. 5 illustrates an exemplary configuration of a communication device according to an embodiment.

FIG. 6 illustrates an exemplary configuration of a communication device (base station device) according to a first embodiment.

FIG. 7 is a flowchart illustrating exemplary user without decoding selection processing according to the first embodiment.

FIG. 8 is a flowchart illustrating exemplary channel-decoding (decoding processing) according to the first embodiment.

FIG. 9 is an explanation of the effects of the first embodiment.

FIG. 10 illustrates an exemplary configuration of a communication device (base station device) according to a second embodiment.

FIG. 11 is a specific example of a priority setting method.

FIG. 12 is a flowchart of exemplary user without decoding selection processing according to the second embodiment.

FIG. 13 illustrates an exemplary configuration of a communication device (base station device) according to a third embodiment.

FIG. 14 is a flowchart illustrating exemplary processing of the decoding start transmission number calculation unit illustrated in FIG. 13.

FIG. 15 illustrates a bundle data representation (TTI bundle size=4 example).

FIG. 16 is an explanation of the decoding start transmission number calculation.

### DESCRIPTION OF EMBODIMENTS

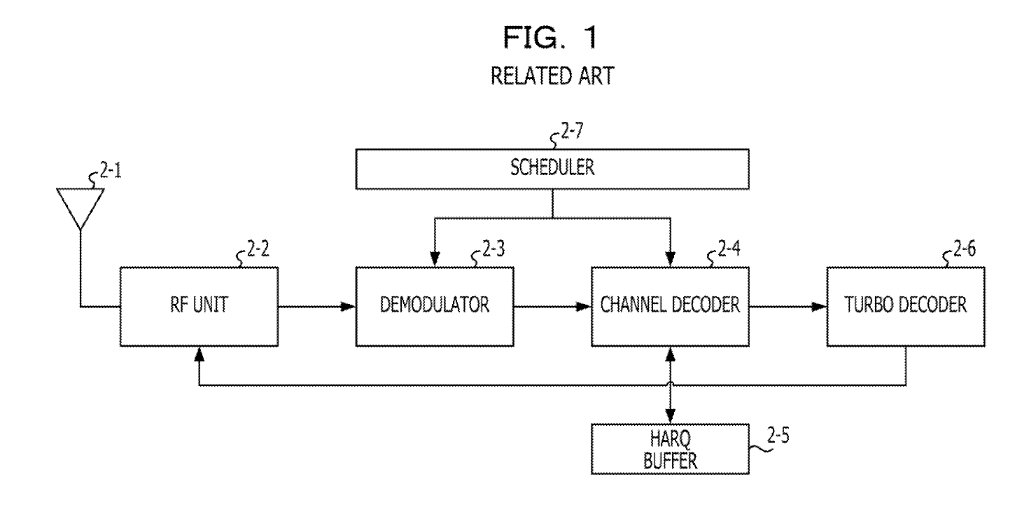

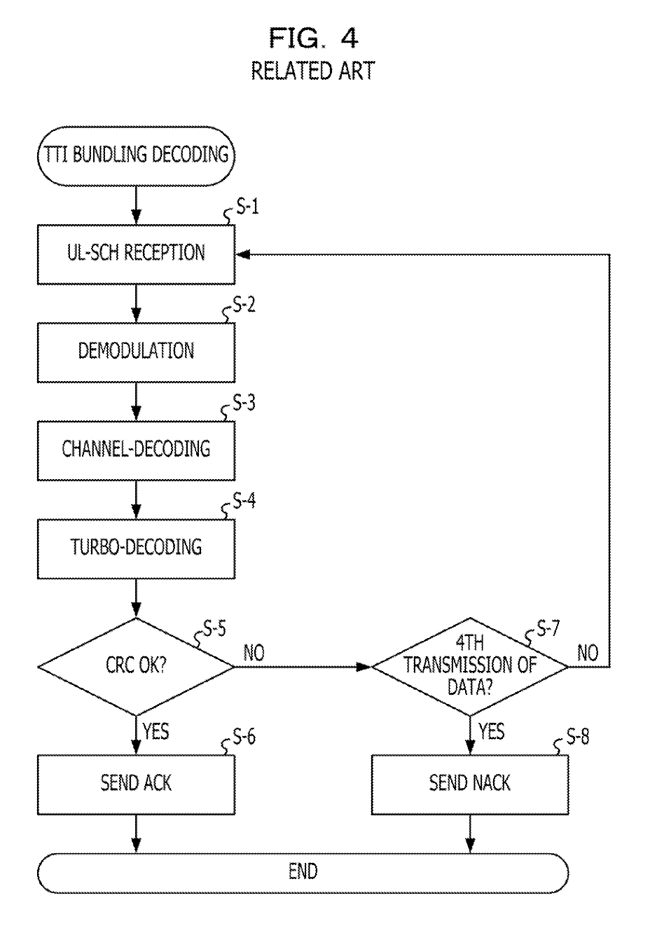

In the related art illustrated in FIGS. 1 to 4, decoding in the base station is sequentially conducted on the TTI bundle data while TTI Bundling is applied. When the CRC evaluation result is OK, the decoding is stopped and a feedback command is sent to the UE at a prescribed timing. As a result, decoding can be conducted while reducing energy consumption.

However, the processing amount of the base station may be greatly increased when the decoding processing on the received TTI bundle data is conducted sequentially without conditions. There is a concern that a large increase in the amount of processing by the base station may lead to a decrease in the base station capacity (line capacity) and lower frequency usage efficiency and the like.

An object of an embodiment of the present invention is to provide a technique that can achieve efficient decoding on transmission data sent a predetermined number of times from a communication partner.

The following method is used in an embodiment to achieve the abovementioned object. That is, an embodiment of the present invention describes a decoding device having a decoding unit that conducts decoding on transmission data sent a predetermined number of times from respective ones of a plurality of communication partners; an identifying unit that identifies transmission data to be decoded by the decoding unit at a certain decoding timing among decoding timings that occur periodically; and a determining unit that determines whether to decode the identified transmission data at the certain decoding timing, based on the number of transmissions in which the identified transmission data has been sent.

Another embodiment of the present invention is, for example, a communication device having the abovementioned decoding device. Moreover, other embodiments of the present invention include a method for determining a decoding target based on the abovementioned decoding device, a program that causes a computer to function as the abovementioned decoding device, or a computer-readable recording medium with the above program recorded therein, which when executed by a processor, causes a computer to perform functions of the abovementioned decoding device. The recording medium may include a semiconductor memory such as a ROM, RAM or a flash memory, a disk-type recording medium such as a CD-ROM, a DVD-ROM, or a Blue-ray disk, or a portable recording medium such as a USB memory.

According to an embodiment of the present invention, efficient decoding can be implemented on transmission data sent a predetermined number of times from a communication partner.

In the following description, embodiments of the present invention will be described with reference to the accompanying drawings. Configurations of the embodiments are merely examples and the present invention is not limited to such configurations.

A communication device that includes the decoding device described in the following embodiments may be, for example, a base station device in a mobile communication system. However, the base station device is merely an example and the communication device according to the embodiments may also be applicable to a mobile terminal (mobile station). In the following explanation, the communication device refers to, for example, a base station device, and the communication device acting as a communication partner refers to, for example, a mobile terminal (UE).

The communication device can conduct HARQ control using TTI Bundling for communication (uplink communication from the standpoint of the UE) with the UE functioning as a communication partner.

That is, the communication device can receive wireless signals from a UE through a receiving antenna when conducting uplink communication with a UE. The wireless signals include encoded data that has been error-correction encoded such as turbo-encoded, modulated under a predetermined modulation system, and channel-encoded.

If TTI Bundling is implemented, the data transmission of the same encoded data from the UE is repeatedly implemented a prescribed number of times according to the TTI_BUNDLE_SIZE. For example, if the TTI bundle size is “4”, the data transmission of the same encoded data is repeatedly conducted as one initial transmission and then three retransmissions for a total for four times from the UE. The initial and retransmission data transmissions are conducted without waiting for feedback commands (ACK/NACK) from the receiving side. The TTI bundle size can be set as appropriate.

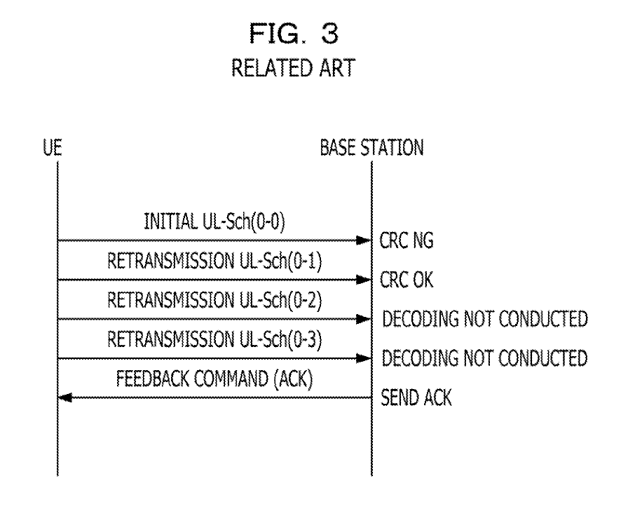

The communication device sends the results (ACK/NACK) of the decoding of the received transmission data, i.e., received data, as feedback commands to the UE for each reception of the number of transmissions according to the TTI bundle size and the transmission data (see FIGS. 1 and 3). That is, the communication device down-converts the wireless signals received via the reception antenna to obtain baseband signals (received data). Then, the communication device conducts demodulation on the received data to obtain demodulated data. Further, the communication device decodes the demodulated data. The decoding includes channel-decoding on the demodulated data, and error-correcting decoding such as turbo-decoding on the channel-decoded data obtained from the channel-decoding. The communication device conducts CRC calculation on the data received as a result of the error-correcting decoding. If the CRC calculation result is OK, the ACK feedback command is sent to the UE, and if the result is NG, the NACK feedback command is sent.

The received data received from the UE is stored in a temporary storage region called a HARQ buffer in the communication device, and recovery from an error condition of the received data is conducted (HARQ control) by combining the received data with the same data (stored previously in the HARQ buffer) received earlier from the same UE. The method of combining the received data under HARQ control may be appropriately selected from existing combination methods and applied.

### First Embodiment

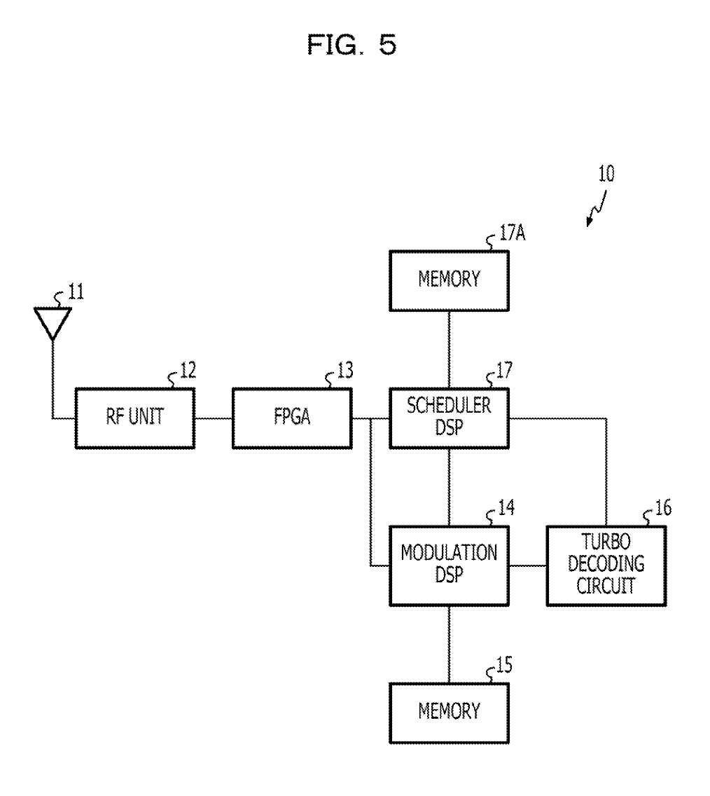

First, a hardware configuration of the communication device using the data decoding device according to the embodiments of the present invention will be described. FIG. 5 illustrates an exemplary configuration of a wireless communication device. As illustrated in FIG. 5, a communication device 10 is equipped with a transmission antenna 11, a RF unit 12 connected to the transmission antenna 11, and a Field Programmable Gate Array (FPGA) 13 connected to the RF unit 12. The RF unit 12 controls processing. For example, the RF unit 12 down-converts radio frequency signals received by the transmission antenna 11 to baseband signals and up-converts baseband signals to radio frequency signals and then sends the signals from the transmission antenna 11.

The FPGA 13 is programmed to conduct decoding on baseband signals (received data) outputted by the RF unit 12, and modulates the baseband signals according to the modulation type implemented by a UE (not shown).

The communication device 10 also includes a modulation Data Signal Processor (DSP) 14 and a scheduler DSP 17 connected to the FPGA 13. The modulation DSP 14 is connected to a memory (storage) 15, and the scheduler DSP 17 is connected to a memory (storage) 17A. The modulation DSP 14 is also connected to a turbo-decoding circuit 16.

The modulation DSP 14 controls channel-decoding of the demodulated data outputted from the FPGA 13 by executing a program stored in a storage such as the memory 15. The modulation DSP 14 temporarily stores the channel-decoding results in the memory 15 and combines the received data together to correct the data errors of the received data based on HARQ control.

The memory 15 stores a program executed by the modulation DSP 14 and stores the data used while the program is running. The memory 15 is used as a temporary storage region (buffer) of the HARQ control data, and as a work region for temporarily saving data and combining data.

The turbo decoding circuit 16 conducts turbo-decoding on the data turbo-encoded at data transmission from the results of the channel decoding, that is the channel decoded data, outputted from the modulation DSP 14.

The scheduler DSP 17 reads information (for example, information needed for modulating and decoding data such as resource assignment conditions for the UEs and signal modulation systems) stored in the memory 17A and provides the information as scheduling information to the modulation DSP 14 and the turbo decoding circuit 16. That is, the scheduler DSP 17 provides operation control information related to data modulation and decoding to the modulation DSP 14 and the turbo decoding circuit 16.

The memory 17A stores a program implemented by the scheduler DSP 17 and stores the data used when running the program. The memory 17A also saves data required for scheduling the demodulation and decoding of data.

Dedicated hardware (integrated circuitry) such as an Application Specific Integrated Circuit (ASIC) may be adopted in place of the abovementioned FPGA 13 and the DSP (microprocessor) 14 and 17.

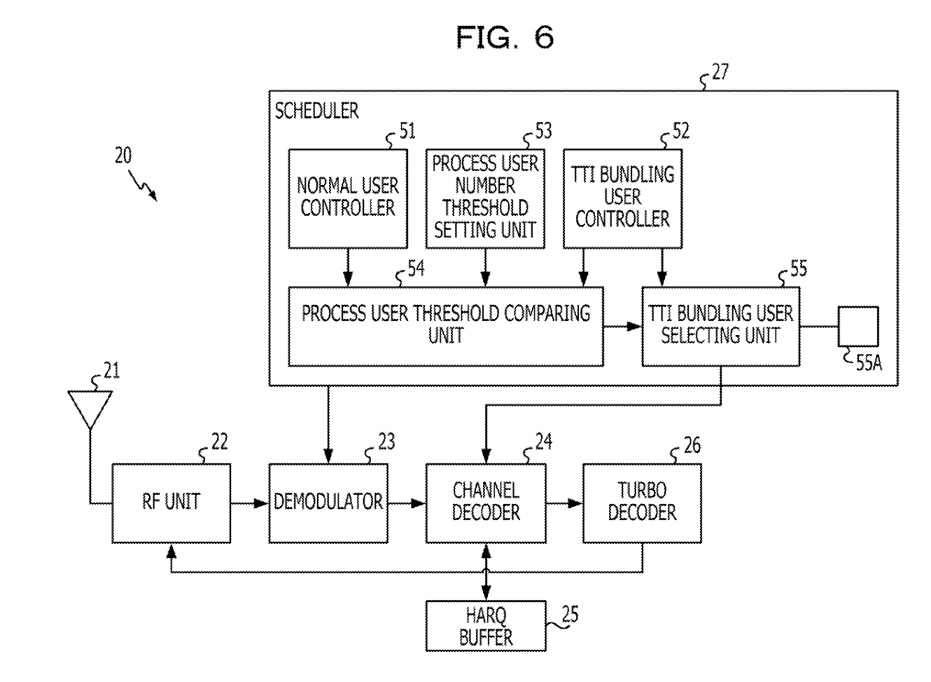

The communication device 10 illustrated in FIG. 5 may function as the communication device 20 illustrated in FIG. 6. The communication device 20 in FIG. 6 is equipped with a transmission antenna 21 corresponding to the transmission antenna 11, a RF unit 22 corresponding to the RF unit 11, and a demodulator 23 realized by programmed logic implemented by the FPGA 13. The demodulator 23 receives, from the scheduler 27, scheduling information including the modulation system of the received data, and conducts demodulation.

The communication device also includes a channel decoder 24 and a HARQ buffer 25. The channel decoder 24 functions are enabled by the modulation DSP 14 (microprocessor) executing a program recorded in the memory 15. The channel decoder 24 conducts channel-decoding on the demodulated data stored in the HARQ buffer 25 to obtain channel-decoded data. The HARQ buffer 25 is created in a storage region of the memory 15 to temporarily store demodulated data.

The communication device 20 also includes a turbo decoder 26 and a scheduler 27. The turbo decoder 26 is enabled by the turbo decoding circuit 16. The turbo decoder 26 conducts turbo-decoding on the channel decoded data obtained from the channel decoder 24, and conducts CRC calculation on the obtained decoding results. The scheduler 27 functions are enabled by the scheduler DSP 17 executing a program stored in the memory 17A.

Although not shown, the communication device 10 (20) illustrated in FIGS. 5 and 6 includes hardware for operating a transmission system to send data to a communication partner (UE). The hardware for operating the transmission system may also include hardware for conducting, for example, error-correction encoding, modulation, and channel-encoding. The hardware for conducting error-correction encoding, modulation, and channel-encoding may use ASIC (integrated circuitry), FPGA, DSP, or any combination of the three. The channel-encoded data is up-converted to radio frequency data by the RF unit 22 and sent from the transmission antenna 21. This type of transmission system allows for the transmission of OK/NG evaluation result (feedback commands) data based on the CRC calculation results to the communication partner (UE).

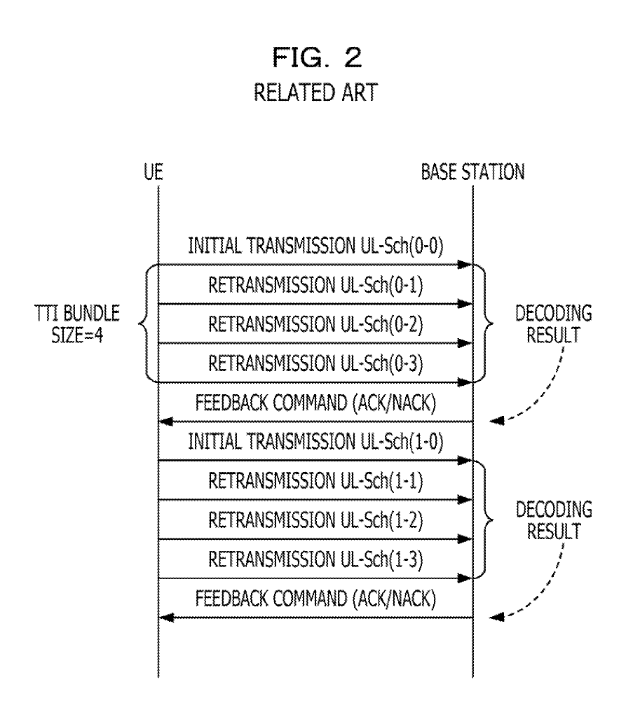

Decoding of the received data is sequentially conducted without conditions in the exemplary configuration of the communication device illustrated in FIG. 2. That is, decoding (channel-encoding, turbo-decoding, CRC calculation) of both the retransmission data (received data) and the initial transmission data arriving at the communication device based on the TTI bundle size is conducted without conditions. As a result, the amount of processing by the communication device may increase, the line capacity of the base station may decrease, and the radio frequency usage efficiency may drop.

In consideration of the above problem, to reduce the amount of processing, the communication device 20 (communication device 10) illustrated in FIG. 6 adaptively controls decoding subframes (decoding timing) of the encoded data received from a user using TTI Bundling according to the number of transmissions of the user and the decoding load conditions.

Therefore, the scheduler DSP 17 (scheduler 27) can function as a device that includes a normal user controller 51, a TTI Bundling controller 52 (hereinafter referred to as a “bundling user controller 52”), a process user number threshold setting unit 53 (hereinafter referred to as a “threshold setting unit 53”), a process user threshold comparing unit 54 (hereinafter referred to as a “comparing unit 54”), and a TTI Bundling user selecting unit 55 (hereinafter referred to as a “selecting unit 55”).

The normal user controller 51 controls normal users (users not using TTI Bundling). The bundling user controller 52 controls the number of users using TTI Bundling and the number of data transmissions of each user. The threshold setting unit 53 sets the process user number. Here, a “user” indicates a communication partner (a UE in this embodiment) of the communication device 20. The comparing unit 54 compares the number of process users of the subframe with the number of process users threshold. The selecting unit 55 selects a user for which decoding is not conducted among the TTI Bundling users to be processed. The channel decoder 24 conducts channel-decoding based on TTI Bundling user information that indicates the selection or non-selection of decoding on the TTI Bundling users.

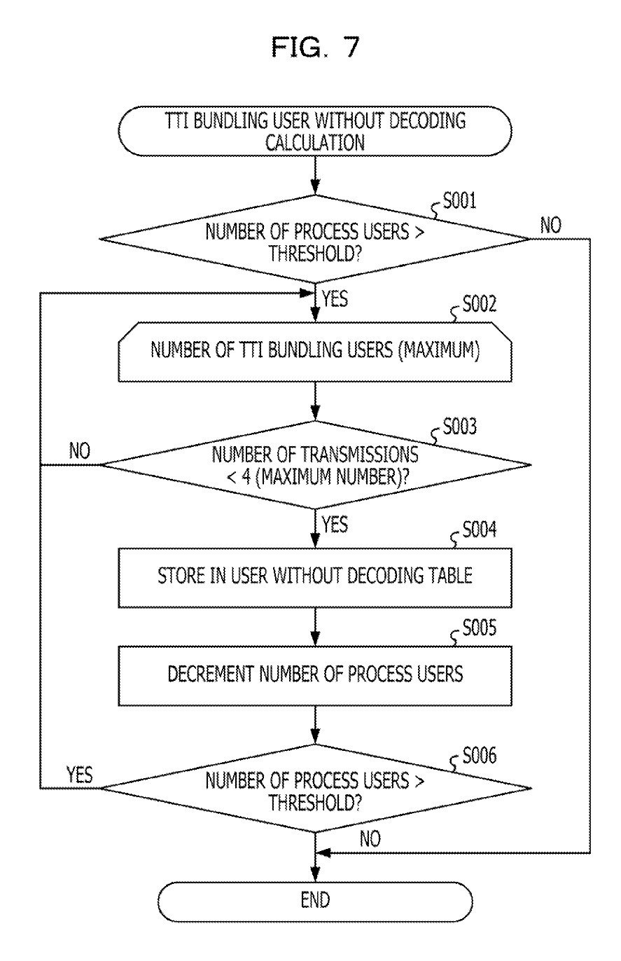

FIG. 7 is a flowchart indicating selection processing conducted by the scheduler 27 to select a user for which decoding is not conducted (user without decoding). The selection process is implemented at predetermined periods. In the present embodiment, the selection processing is conducted at each subframe (subframe time) for receiving data.

The selection processing illustrated in FIG. 7 begins by first comparing the number of process users (S001). That is, in step S001, the comparing unit 54 reads the number of normal users to receive decoding in the current subframe from the normal user controller 51, and reads the number of bundling users to receive decoding in the current subframe from the bundling user controller 52. Next, the comparing unit 54 calculates the sum (number of users to receive decoding processing in the current subframe, i.e., the number of process users) of the number of normal users and the number of the bundling users. Furthermore, the comparing unit 54 reads the process user number threshold set by the threshold setting unit 53. In the present embodiment, the threshold is temporarily set at “4” users. However, the threshold may be set appropriately.

The comparing unit 54 compares the number of process users with the threshold and determines whether or not the number of process users is larger than the threshold. If the number of process users is not larger than the threshold, the comparing unit 54 determines that the processing load condition of the communication device 20 is not high and the selection processing is completed. Conversely, if the number of process users is larger than the threshold, the comparing unit 54 determines that the processing load condition of the communication device 20 is high, and the process advances to step S002.

The loop processing in steps S002 to S006 is conducted by the selecting unit 55 that receives notification from the comparing unit 54 indicating that the load condition is high. The notification may also include the number of process users (sum). The loop processing is conducted repeatedly as needed to set the maximum value for the number of bundling users.

In step S002, the selecting unit 55 selects a predetermined number of bundling users among one or more bundling users controlled by the bundling user controller 52, and receives the number of data transmissions of the selected bundling users from the bundling user controller 52. The bundling users selection method may be determined appropriately. In the first embodiment, the bundling users are selected in order by a user number previously set for each bundling user controlled by the user controller 52.

The bundling user controller 52 saves, for each bundling user, data that indicates the number of the data transmissions (1 to 4 in the present embodiment with 4 being the maximum) of the received data in each subframe according to the TTI bundle size.

Next, in step S003, the selecting unit 55 determines whether or not the number of the data transmissions is smaller than a threshold for the number of transmissions (maximum number of transmissions). Here, the threshold for the number of transmissions is a TTI bundle size of 4.

If the number of data transmissions is smaller than the threshold (S003, YES), the selecting unit 55 processing advances to step S004 under the premise that an opportunity to conduct decoding of the data received from the bundling user can be assured in subsequent subframes. The process advances to step S004. Conversely, if the number of data transmissions is equal to or greater than the threshold (S003, NO), the selecting unit 55 processing returns to step S002 under the premise that the current subframe is the last opportunity for the data received from the bundling user to be decoded.

When the process returns to step S002, the selecting unit 55 obtains the number of data transmissions of the next bundling user from the bundling user controller 52 and conducts the processing from step S003.

If the processing advances to step S004, the selecting unit 55 sets the user information of the bundling user in a TTI Bundling user without decoding table 55A (hereinafter referred to as a “table 55A”) to prevent the decoding of the bundling user to be conducted in the current subframe. The table 55A can be created in, for example, a storage region of the memory 17A.

Next, the selecting unit 55 decrements the number of process users (step S005). That is, the selecting unit 55 reduces the number of process users by 1.

Next, the selecting unit 55 determines whether or not the number of process users is larger than a threshold for determining a high load condition (step S006). If the number of process users is greater than the threshold (S006, YES), the selecting unit 55 processing returns to step S002 under the premise that high load conditions are continuing. Conversely, if the number of process users is equal to or less than the threshold (S006, NO), the selecting unit 55 completes the loop processing under the premise that the high load condition has disappeared. Then the selection processing is completed.

As described above, the selection processing is implemented under a condition where the number of users to receive decoding according to the current subframe exceeds the threshold (high load condition). In the selection processing, the selecting unit 55 selects a bundling user that does not receive decoding according to the current subframe from among one or more bundling users controlled by the user controller 52, and stores user information of the selected bundling user in the table 55A. A bundling user whose number of data transmissions does not reach the TTI bundling size is removed from becoming a target of decoding due to the selection processing.

The channel decoder 24 conducts channel decoding based on the scheduling information provided by the scheduler 27. The scheduling information contains information for the channel decoder 24 and the turbo decoder 26 to conduct decoding. For example, the scheduling information can contain information on users to receive decoding in each subframe. The scheduling information may also contain TTI Bundling process information. TTI Bundling process information is user information stored in the above-mentioned table 55A that indicates bundling users that do not receive decoding in the current subframe.

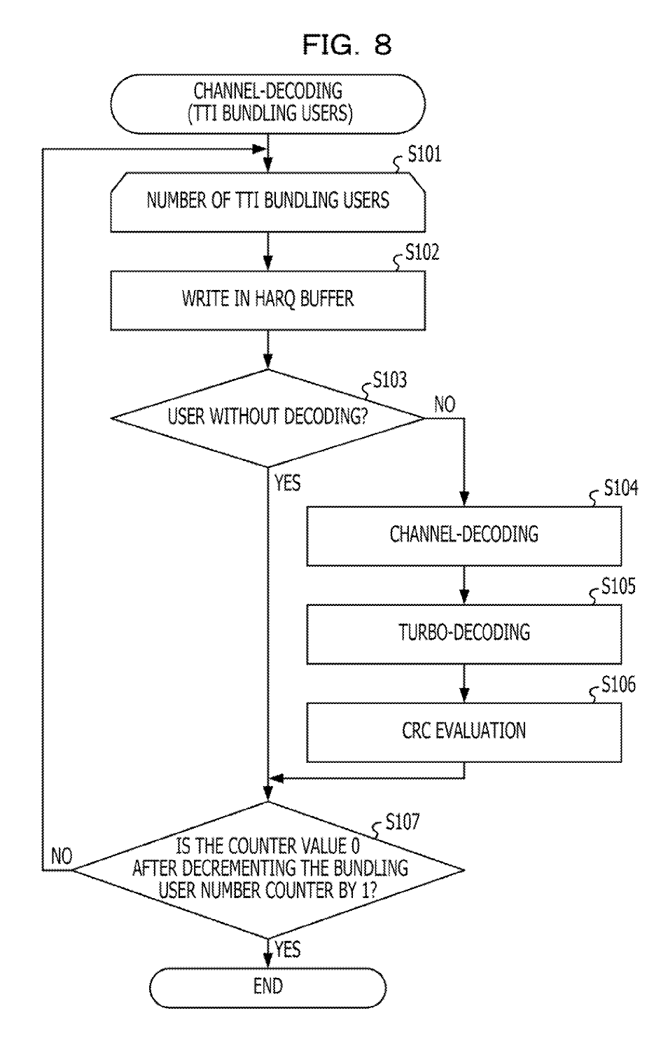

FIG. 8 is a flow chart illustrating exemplary procedures of the channel decoder 24. The channel decoder 24 conducts decoding from the start of the scheduling. The flow chart illustrated in FIG. 8 is conducted in predetermined cycles (in subframes in the present embodiment). Processing targeting the bundling users is illustrated in FIG. 8, but decoding for each subframe is conducted for both the bundling users and the non-bundling users (normal users).

In step S101 of FIG. 8, the channel decoder 24 sets the number of bundling users contained in the schedule information on a counter (not shown). Next, the channel decoder 24 selects one bundling user and writes the demodulated data of the selected bundling user in the HARQ buffer 25 (step S102). The selection of the bundling user is conducted according to the user number given to the bundling users. However, other methods of selecting the bundling users may be used.

Next, the channel decoder 24 performs an evaluation to determine the users without decoding (Step S103). That is, the channel decoder 24 determines whether or not the selected bundling user is a user that does not receive decoding (user without decoding). The determination is based on the contents stored in the table 55A provided by the selecting unit 55.

If the bundling user is a user without decoding (S103, YES), the process returns to steps S101 and the loop processing is conducted for the remaining bundling users. The loop processing is conducted on all the bundling users.

Conversely, if the bundling user is not a user without decoding (S103, NO), the channel decoder 24 conducts channel-decoding on the demodulated data of the bundling user (Step S104). If desired, the channel decoder 24 combines the demodulated data of the bundling user stored in the HARQ buffer 25.

Next, the channel decoder 24 sends the channel-decoded data to the turbo decoder 26. The turbo decoder 26 conducts turbo-decoding on the channel-decoded data (Step S105). Furthermore, CRC calculation is conducted on the data obtained from the turbo-decoding result, and an evaluation (CRC evaluation) is conducted to determine whether or not the data is OK or NG (Step S106).

After step S106 is completed, the bundling user counter set in step S101 is decreased by 1 and the process returns to step S101 if the reduced counter value is not 0. If the decreased counter value is 0, the loop processing and the channel-decoding are completed for all the bundling users (Step S107).

Based on the above channel-decoding, the decoding for the bundling users and the normal users excluding the bundling users without decoding is conducted in the current subframe. The processing load for the subframe can be reduced by not conducting (avoiding) the decoding for the bundling users selected by the selecting unit 55 in the channel-decoding.

Moreover, the demodulated data of the bundling users (and normal users) is stored in the HARQ buffer 25 regardless of whether or not the decoding is conducted in the above channel-decoding. The stored demodulated data is used when combining the demodulated data with the same demodulated data received in another subframe. As a result, the error content rate of the demodulated data can be reduced. Hence, the amount of unacceptable turbo-decoding results (CRC checks) does not increase due to the channel-decoding implemented as illustrated in FIG. 8. That is, the effects of error recovery with HARQ are maintained and the amount of decoding of the subframes can be reduced.

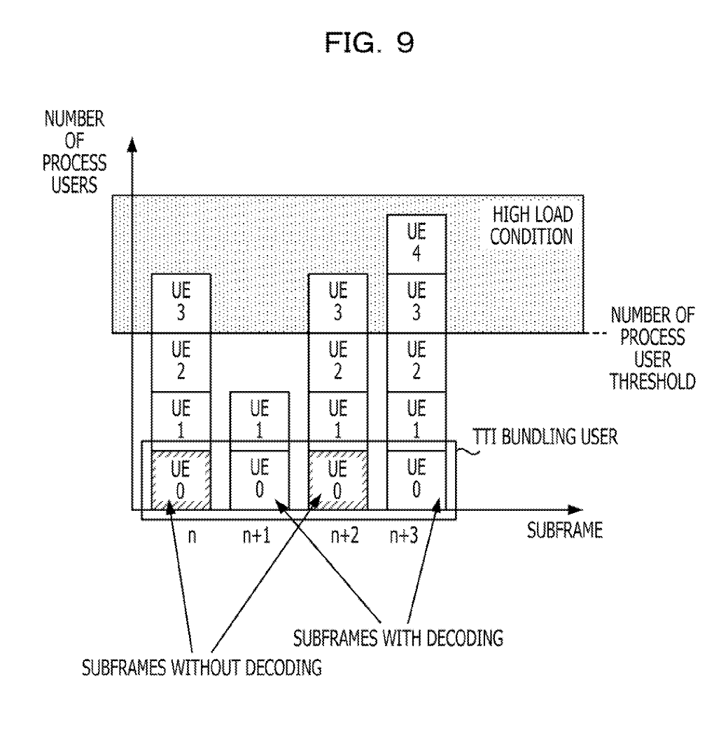

Detailed effects of the first embodiment are explained with reference to FIG. 9. FIG. 9 illustrates time (subframes) on the horizontal axis and the number of process users on the vertical axis. In the example illustrated in FIG. 9, the process user threshold (high load condition determination threshold) is “3 users.” If the number of process users exceeds 3, the base station processing is determined to be in a high load condition. Moreover, “UE0” in FIG. 9 is a bundling user and UE1 to UE4 are non-bundling users.

The number of process users is “4” in the subframes “n” (where “n” is a positive integer), and the load condition is determined as high. Furthermore, the UE0 transmission data is in the first transmission of the transmission data (initial data) from the UE0. As a result, the UE0 is selected by the selecting unit 55 as a user without decoding. As a result, the channel decoder 24 stores the demodulated data of the UE0 in the HARQ buffer 25 but does not conduct decoding for the UE0.

The transmission data of the UE0 in the subframe “n” is the initial transmission data. As a result, retransmission data can be received 3 times in the subframes after the subframe “n” (TTI bundle size=4). In this way, opportunities for decoding remain with the subsequent subframes for the UE0 and thus decoding under a high load condition can be avoided. Thus, the number of users that conduct decoding in the subframe “n” can be reduced (from 4 to 3 in FIG. 9) by avoiding decoding of the UE0 in the subframe “n.”

The next subframe “n+1” is not in a high load condition. As a result, decoding can be conducted for all the users in the subframe “n+1.” Thus, channel-decoding and turbo-decoding of the UE0 transmission data is conducted.

The next subframe “n+2” has a high load condition similar to subframe “n.” Similarly, the transmission data of the UE0 is retransmission data corresponding to the third transmission and thus is determined to be a user without decoding. As a result, decoding of the UE0 transmission data is not conducted.

The next subframe “n+3” is in a high load condition. However, the UE0 transmission data is the fourth transmission of the transmission data (that is, data of the final transmission). As a result, the decoding of the UE0 transmission data is preferably implemented in the subframe “n+3.” In this way, decoding on the finally transmitted transmission data as prescribed by the TTI bundle size is conducted even if the load condition is high. Thus the deterioration of throughput can be avoided.

According to the first embodiment, decoding of the transmission data received up to the third transmission among the transmission data received from a UE corresponding to a TTI Bundling user (bundling user) and received in the transmission according to the TTI bundle size, can be avoided (stopped) when the load condition is high.

The amount of processing of the channel-decoding and the turbo-decoding is larger than, for example, the amount of demodulation processing and comprises a large portion of the receiving processing of a base station. As a result, a large amount the processing can be reduced by stopping the decoding processing as described above.

On the other hand, the processing up to the writing into the HARQ buffer 25 can benefit from the advantageous effects of HARQ (recovery from error state using data combination) since the processing can be conducted regardless of the load condition. Therefore deterioration of characteristics such as a rise in the rate of unacceptable CRC evaluations can be prevented by stopping the decoding as described above. Since the percentage of the processing amount of the writing into the HARQ buffer 25 is very small compared to the processing amount of all the channel-decoding, problems may not occur if the writing processing is conducted on all the demodulated data.

A constant high load condition can be set and users without decoding can always be selected by setting the threshold to determine the high load condition to 1 or less. Conversely, determination of the high load condition can be substantially disabled by setting the threshold to a large value greater than the number of users (UE) that the communication device (base station) can accommodate. Thus, determination of the high load condition will not be a requirement.

### Second Embodiment

The following is a description of a second embodiment of the present invention. The description of the second embodiment will focus on features that are different from the first embodiment and hence the description of common features will be omitted.

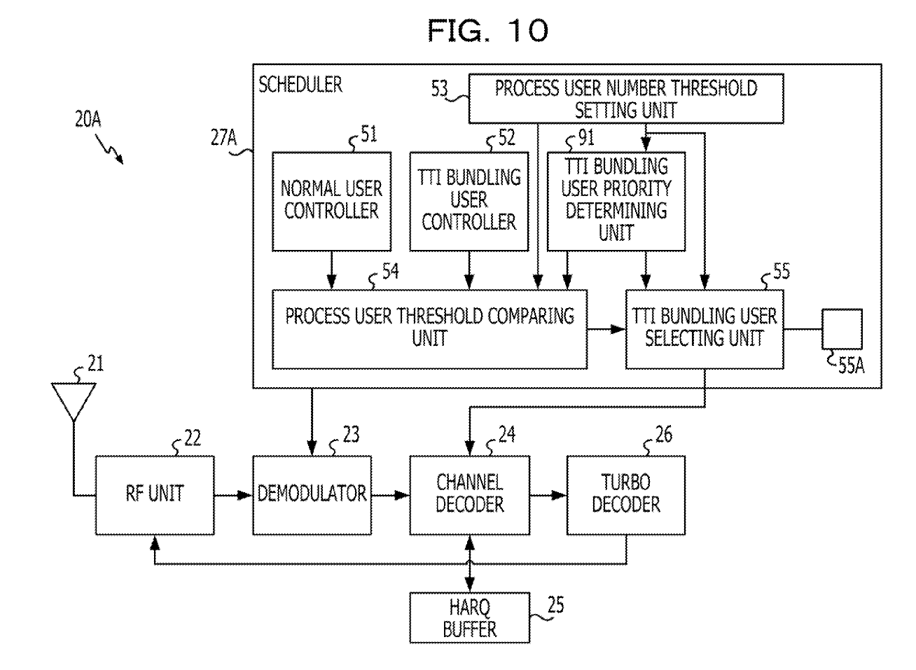

FIG. 10 illustrates an exemplary configuration of a communication device (base station device) according to the second embodiment. The communication device 20A illustrated in FIG. 10 can be enabled with hardware similar to the hardware illustrated in FIG. 5. However the program executed by the scheduler DSP 17 in the second embodiment is different from the program in the first embodiment and some of the functions that enable the program are also different.

Configuration elements in the communication device 20A of the second embodiment illustrated in FIG. 10 that are similar to configuration elements in the first embodiment (FIG. 6) are provided with the same symbols and descriptions thereof will be omitted. The following features of the communication device 20A are different from the communication device 20 described in the first embodiment. A scheduler 27A includes, in addition to the elements of the scheduler 27, a TTI Bundling user priority determining unit 91 (hereinafter referred to as a “determining unit 91”) inserted between the bundling user controller 52 and the selecting unit 55.

The communication device 20 according to the first embodiment selects bundling users in the order of the user numbers controlled by the scheduler 27 instead of especially prescribing priority and the like among the TTI Bundling users (bundling users) when selecting the users without decoding under a high load condition. Conversely, in the second embodiment, priority among the bundling users is determined and the users without decoding are selected in order of lowest priority.

The priority here is defined to give the lowest priority to data with the lowest number of transmissions among the number of data transmissions (number of receptions) in the subframe. For example, a user whose transmission is the third transmission has only one decoding opportunity remaining excluding the current transmission. Conversely, a user whose transmission is the first transmission can have three more decoding opportunities after the current transmission. Therefore, the user whose transmission is the first transmission is given a low priority since the opportunity for decoding in subsequent subframes is relatively high even if the user is not selected as a user without decoding in the current subframe.

Furthermore, data received in the third transmission has a higher possibility of being an acceptable quality transmission (few errors) than the data received in the first transmission due to the combination processing conducted with the HARQ buffer 25, and thus the possibility that the CRC evaluation will be OK is also high. Therefore, wasteful decoding from unacceptable CRC evaluations can be avoided if decoding can be conducted on data from a higher transmission number by setting a high priority for a higher number of transmissions. Thus, the larger amount of processing conducted by the communication device 20 according to the first embodiment can be reduced in the communication device 20A of the second embodiment by assigning priority to the bundling users.

Based on the above, the determining unit 91 receives bundling user information (which may also include the number of bundling users) and the number of data transmissions (number of receptions) of each bundling user from the user controller 52, sorts the bundling users in order from the lowest number of data transmissions, and provides the bundling user information in the sorted order to the selecting unit 55. In this way, the bundling users arranged in order of user number can be rearranged by the determining unit 91 in order of priority based on the number of transmissions. When more than one bundling user is given the same priority level, the order can be determined by appropriate rules. For example, bundling users with the same priority level can be further rearranged using the user numbers.

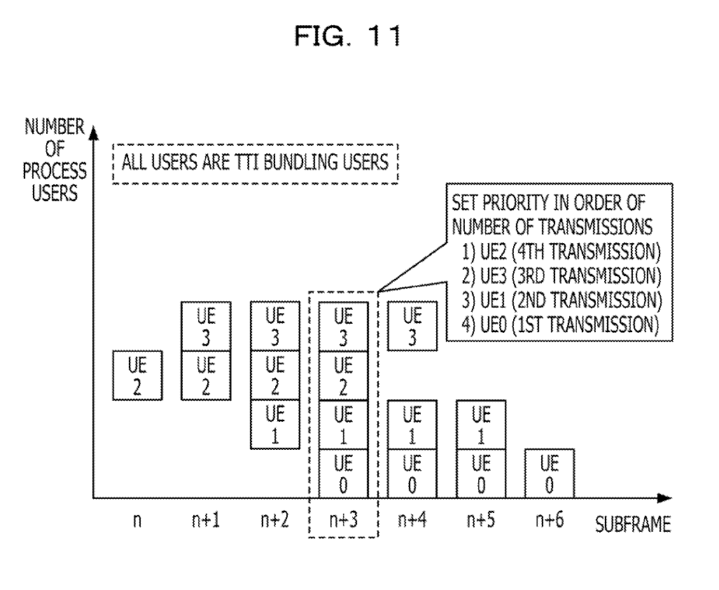

FIG. 11 is a specific example of a priority setting method. FIG. 11 illustrates a case with four bundling users. Looking at subframe “n+3” in FIG. 11, UE0 data is data from the first transmission, UE1 data is data from the second transmission, UE2 data is data from the fourth transmission, and UE3 data is data from the third transmission. In this case, priority is determined in order from the lowest transmission number and thus when the UEs from UE0 to UE3 are arranged in order from the lowest priority, the order becomes UE0, UE1, UE3, and UE2.

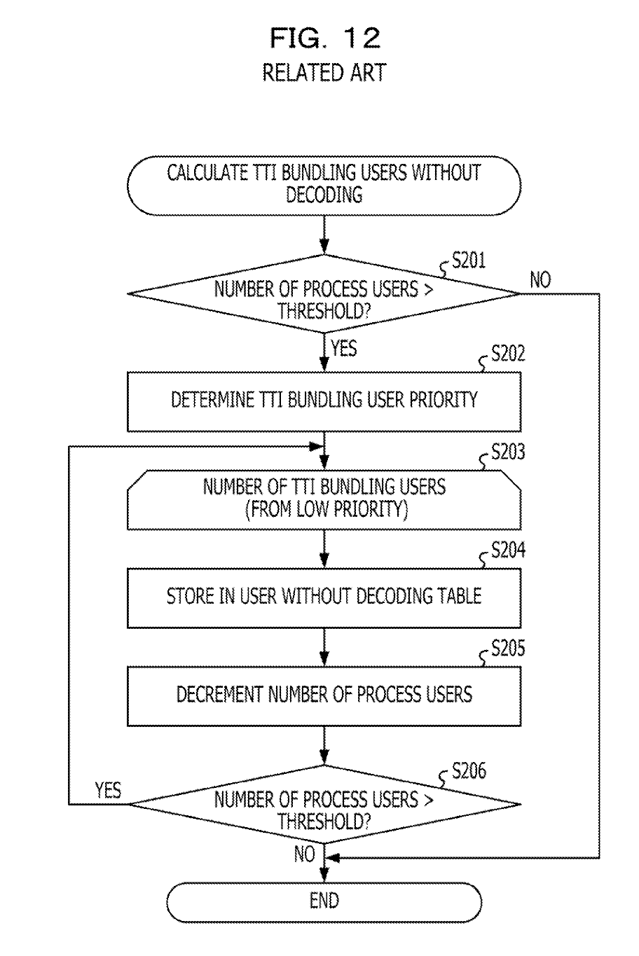

FIG. 12 is a flowchart of exemplary user without decoding selection processing according to the second embodiment. The selection processing illustrated in FIG. 12 is conducted for each subframe in the same way as the first embodiment. The determination of the high load condition in step S201 is conducted in the same way as the processing in step S001 in the selection processing according to the first embodiment (FIG. 7). However, the comparing unit 54 notifies the selecting unit 55 and the determining unit 91 that the load condition is high when a high load condition (number of process users>threshold) is determined.

The priority selection processing in step S202 is conducted by the determining unit 91 after receiving the high load condition notification. That is, the determining unit 91 rearranges the bundling user information of the bundling users controlled by the user controller 52 in order from the fewest number of data transmissions (lowest priority), and sends the rearranged information to the selecting unit 55.

The steps S203 to S206 are conducted by the selecting unit 55. In step S203, the selecting unit 55 selects one bundling user according to the order (order of lowest priority) determined by the determining unit 91. In step S204, the selecting unit 55 stores the user information of the bundling user selected in step S203 in the table 55A without conditions.

Next, the selecting unit 55 reduces (decrements) the number of process users sent by the comparing unit 54 by one (step S205) and determines whether or not the number of process users is larger than the threshold (step S206).

If the number of process users is larger than the threshold (S206, YES), the processing returns to step S203 and the next bundling user is selected. Conversely, if the number of process users is equal to or smaller than the threshold (S206, NO), the loop processing from step S203 to step S206 is completed and the selection processing is ended. The selection processing may be completed if the processing on all the bundling users is completed before the number of process users becomes equal to or less than the threshold.

Therefore, according to the selection processing illustrated in FIG. 12, all the bundling users selected in step S203 up to the point where the number of process users becomes equal to or less than the threshold (where the high load condition disappears) enter a state where the bundling users are registered as users without processing in the table 55A. The stored contents (users without decoding) of the table 55A are sent to the channel decoder 24 as part of the schedule information. The processing of the channel decoder 24 and the turbo decoder 26 is the same as the first embodiment and the description thereof will be omitted here.

The processing illustrated in FIG. 12 is merely an example. For example, a method of selecting a number of bundling users equal to a difference between the number of process users and a threshold by previously calculating the number of users that exceeds the number of users to receive decoding in one subframe, as users without decoding priority as a group from the lowest priority, may be considered. The following configuration may be adopted, for example, to allow for the above method. That is, the comparing unit calculates the difference and provides the difference to the selecting unit 55. The selecting unit 55 receives a list of bundling users sorted in order from the lowest priority by the determining unit 91 and then selects multiple bundling users corresponding to the difference from the list in order from the lowest priority.

The effects achieved in the first embodiment may also be achieved with the second embodiment. Furthermore, bundling users with the lowest number of transmissions are given the lowest priority and users without decoding are selected in order from the lowest priority according to the second embodiment. As a result, users without decoding can be selected more appropriately than in the first embodiment so that unacceptable CRC evaluations can be reduced and the processing load can be reduced.

### Third Embodiment

The following is a description of a third embodiment of the present invention. The description of the third embodiment will focus on features that are different from the first and second embodiments and the description of common features will be omitted.

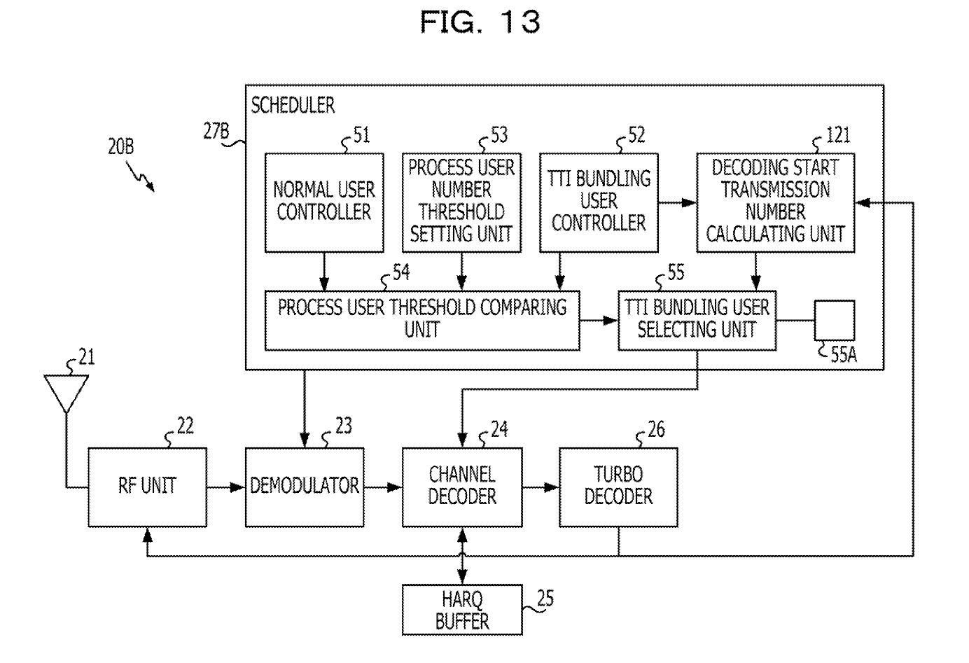

FIG. 13 illustrates an exemplary configuration of a communication device (base station device) according to the third embodiment. A communication device 20B illustrated in FIG. 13 can be enabled with hardware similar to the hardware illustrated in FIG. 5. However the program executed by the scheduler DSP 17 in the second embodiment is different from the program in the first embodiment and some of the functions that enable the program are also different.

The communication device 20B illustrated in FIG. 13 has a scheduler 27B that corresponds to the scheduler 27 of the communication device 20 of the first embodiment. The scheduler 27B is equipped with a decoding start transmission number calculating unit 121 (hereinafter referred to as a “calculating unit 121”) that determines the decoding start transmission number corresponding to the TTI Bundling data for each TTI Bundling user (bundling user).

In the following description, “TTI Bundling data (bundle data)” indicates a collection of a series of data transmissions sent a predetermined number of times based on the TTI bundle size. Blocks of transmission data making up the bundle data will be referred to as “data” or “transmission data.”

Furthermore, the TTI Bundling user selecting unit 55 included in the scheduler 27B stores the bundling users in the users without decoding table 55A when the decoding start transmission number does not meet the number of transmissions of the bundling user data.

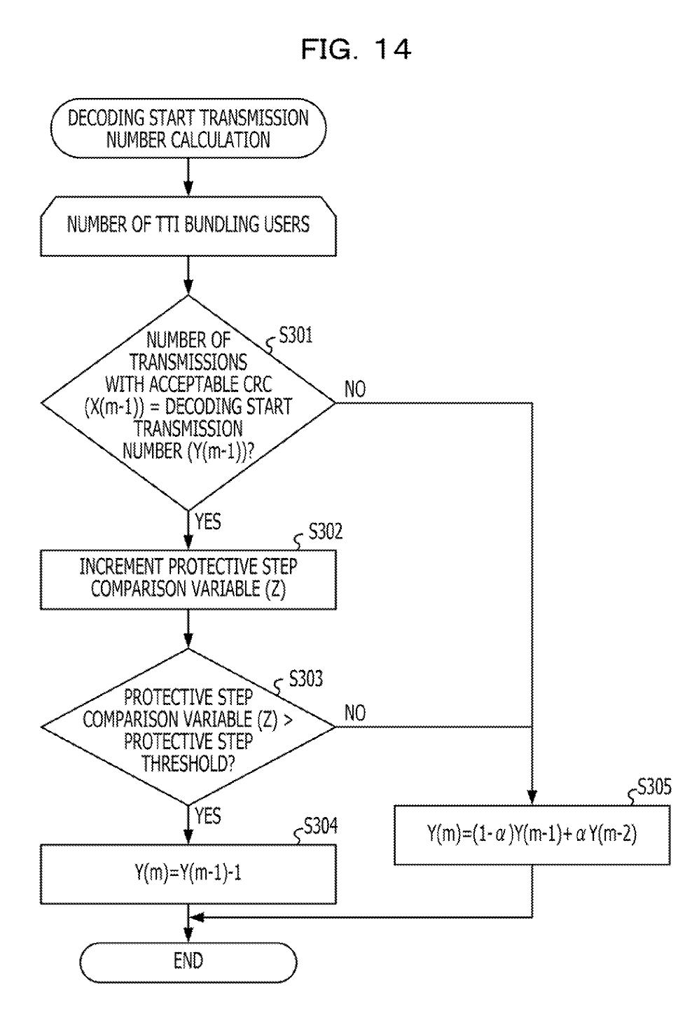

FIG. 14 is a flow chart illustrating an example of processing (calculation processing) conducted by the decoding start transmission number calculating unit 121 to calculate the decoding start transmission number. The calculation processing illustrated in FIG. 14 is conducted periodically. For example, the calculation processing can be conducted for each bundling user to determine the decoding start transmission number at or before the subframe in which the initial transmission data of the current bundle data is received.

The calculating unit 121 repeatedly conducts loop processing from steps S301 to S304 on the bundling users controlled by the user controller 52 that have started a new bundle data transmission (reception).

Before the step S301, the calculating unit 121 selects one bundling user to determine the decoding start transmission number. The selection of the bundling user may be conducted, for example, according to the order of the user number previously given to the bundling users as described in the first embodiment. However, other selection methods may also be used.

In step S301, the calculating unit 121 compares the number of data transmissions X(m−1) with acceptable CRC evaluations from the previous bundle data decoding for bundling users selected in the previous processing, with the number of decoding start transmissions determined in the previous bundle data decoding (previous decoding start transmission number Y(m−1)).

If the number of transmissions X(m−1) equals the previous decoding start transmission number Y(m−1) (S301, YES), the calculating unit 121 increments a protective step comparison variable Z (adds 1 to the value of Z) (step S302).

Next, the calculating unit 121 compares the incremented protective step comparison variable Z with a previously prepared protective step threshold (step S303). If the variable Z is larger than the protective step threshold (S303, YES), the calculating unit 121 sets the decoding start transmission number Y(m) related to the decoding of the current bundle data to a value reduced by 1 from the decoding start transmission number Y(m−1) from the previous bundle data decoding.

On the other hand, if the number of transmissions X(m−1) does not equal the previous decoding start transmission number Y(m−1) (S301, NO), and the protective step comparison variable Z does not exceed the protective step threshold (S303, NO), the calculating unit 121 calculates the decoding start transmission number Y(m) of the current bundle data decoding using the following averaging equation (1) (step S305).

Y(m)=(1−α)Y(m−1)+αY(m−2) (1)

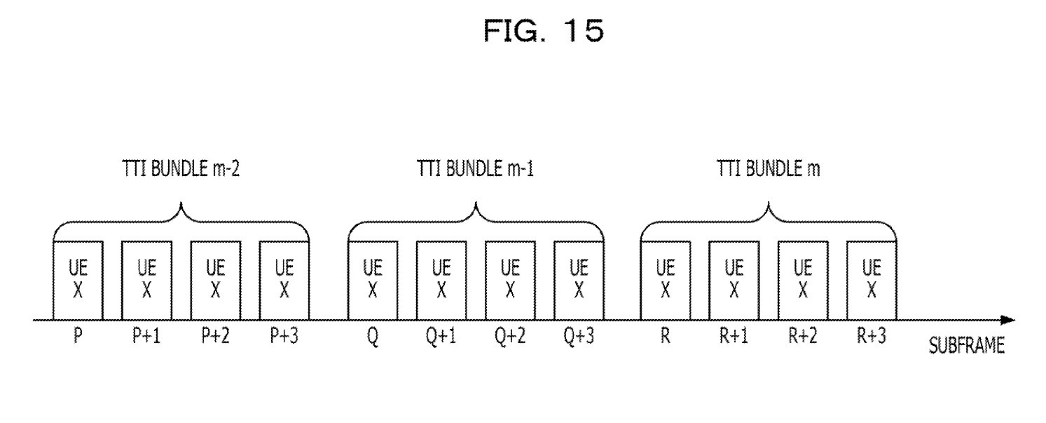

Here, “m” in the above equation represents bundle data, that is, one block of the same data transmitted a predetermined number of times according to the TTI bundle size, and is illustrated as a bundle data representation (TTI bundle size=4) in FIG. 15. An interval of a predetermined number of subframes set with a parameter is provided between each bundle data block. The calculation for each bundling user is conducted during the interval.

The above equation (1) represents a forgetting average. In equation (1), “α” is a forgetting coefficient (0≦α≦1) that is determined in consideration of propagation path characteristics and the like. The averaging in step S305 may be obtained from an effect of averaging the number of transmissions when the CRC evaluation is OK by using an interval average in place of the forgetting average.

In this way, the calculating unit 121 decides to introduce the decoding of the bundle data of the bundling user with the decoding start transmission number Y(m) calculated in steps S304 and S305 in the above calculation processing.

The determined number of decoding start transmissions Y(m) for each bundling user is sent to the selecting unit 55. In the selection of users without decoding for each subframe, the selecting unit 55 selects the bundling user whose number of transmissions has not reached the decoding start transmission number Y(m) among the bundling users to receive decoding in the current subframe, and writes the selected bundling user in the table 55A. On the other hand, the selecting unit 55 determines whether or not to select the bundling user whose number of transmissions has reached the decoding start transmission number Y(m) as a user without decoding according to a process similar to the process described in the first embodiment. The decoding of the bundling user that has reached the decoding start transmission number Y(m) may be forcibly conducted in the subframe corresponding to the decoding start transmission number Y(m).

The processing from the reception of the wireless signals by the transmission antenna 21 including the bundle data, to the acquisition of the demodulated data demodulated by the demodulator 23, and the decoding conducted by the channel decoder 24 and the turbo decoder 26 is similar to the corresponding processing described in the first embodiment and description thereof will be omitted here.

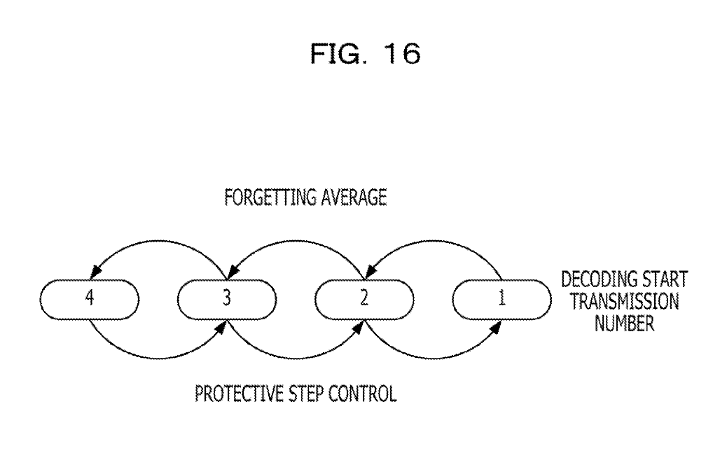

FIG. 16 is an explanation of the decoding start transmission number calculation. In the third embodiment, controlling toward the smaller decoding start transmission numbers is protective step control, and controlling toward the larger decoding start transmission numbers is control with the forgetting average.

Decoding in the third embodiment starts from the decoding start transmission number determined by the calculation processing. As a result, the transmission number when the CRC evaluation is OK may be equal to or exceed the decoding start transmission number when attempting to control temporarily with only the averaging. Therefore, the value of the decoding start transmission number does not become smaller when only using averaging.

As a result, the protective step controlling is introduced in the third embodiment. That is, when the number of acceptable CRC evaluations for the set decoding start transmission number continues for a predetermined number of protective steps, the decoding start transmission number is set to one less than the current decoding start transmission number with the assumption that the propagation path characteristics in a wireless zone between the communication device 20B and the communication partner (UE) are acceptable. The protective step threshold is set in consideration of the propagation path characteristics.

The effects achieved in the first embodiment may be achieved by the third embodiment. Moreover, the next decoding start transmission number is determined in the third embodiment with the averaged value of the number of transmissions when the CRC evaluation is OK. The number of transmissions with the acceptable CRC evaluation is determined according to a bundling user state such as the propagation path characteristics. As a result, the number of transmissions in which the CRC is OK during the decoding of the next bundle data can be estimated with the averaging. Therefore, wasteful decoding that leads to unacceptable CRC evaluations can be reduced by starting (stopping the selection as the user without decoding) the decoding from the calculated decoding start transmission number when decoding the next bundle data. Conversely, if the number of transmissions with acceptable CRC evaluations continues for multiple protective steps due to the set decoding start transmission number, the propagation path characteristics are considered acceptable and decoding can be attempted with even one less number of transmission. An optimal decoding start transmission number can be estimated with the abovementioned averaging and protective step processing, and the amount of processing can be reduced without deterioration in characteristics.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has (have) been described in detail, it should be understood that the various changes, substitutions, and alterations could be made hereto without departing from the spirit and scope of the invention.

1. A decoding device comprising:
a decoder that conducts decoding on transmission data sent a predetermined number of transmissions from respective communication partners; and
a scheduler that identifies transmission data to be decoded by the decoder at a certain decoding timing among decoding timings that occur periodically and that determines whether to decode the identified transmission data at the certain decoding timing, based on a number of transmissions in which the identified transmission data has been sent.

2. The decoding device as in claim 1, wherein
the scheduler decides to not conduct decoding of the identified transmission data at the certain timing when the number of transmissions of the identified transmitted data is not larger than a prescribed number of transmissions smaller than the predetermined number of transmissions.

3. The decoding device as in claim 1, wherein
the scheduler determines that at least one block of the transmission data is omitted from decoding at the certain decoding timing when a number of blocks of the transmission data to be decoded at the certain decoding timing exceeds a threshold value.

4. The decoding device as in claim 3, wherein
the scheduler stops determining a transmission data block to be omitted from decoding remaining transmission data blocks when a number of the blocks of transmission data to be omitted from decoding at the certain timing is determined from among the plurality of transmission blocks, the number corresponding to a difference between the threshold value and the number of blocks of transmission data.

5. The decoding device as in claim 1, further comprising:
a memory that stores and combines the transmission data sent in a number of transmissions smaller than the predetermined number of transmissions with transmission data sent after the transmission of the transmission data.

6. The decoding device as in claim 1, wherein
the identifying unit identifies a plurality of blocks of transmission data to be decoded at one decoding timing; and
the scheduler further that gives a low priority to each of the blocks of transmission data when the number of transmissions of the blocks of transmission data is low, wherein that determines at least one block of transmission data that is to be omitted from decoding in one of the decoding timings in order from the lowest priority, from among the plurality of blocks of transmission data.

7. The decoding device as in claim 1, wherein
the transmission data sent the predetermined number of transmissions is sent periodically from each communication partner, and
the scheduler further that determines a decoding start transmission number that is the number of transmissions of the transmission data to become an identification target identified by the scheduler, the transmission data sent the predetermined number from each communication partner.

8. The decoding device as in claim 7, wherein
the scheduler determines, as the decoding start transmission number, an average value of the number of transmissions when an acceptable decoding result is obtained from each communication partner.

9. The decoding device as in claim 7, wherein
the transmission number determining unit decreases the decoding start transmission number of a communication partner when acceptable decoding results of the transmission data are obtained a predetermined number in series for the communication partners.

10. A decoding target determining method comprising:
decoding transmission data sent a predetermined number of transmissions from respective communication partners;
identifying transmission data to be decoded by a decoding unit at a certain decoding timing among decoding timings that occur periodically; and
determining whether to decode the identified transmission data at the certain decoding timing, based on a number of transmissions in which the identified transmission data has been sent.

11. A computer-readable storage medium storing a program which, when executed by a processor, performs a method of determining a decoding target, the method comprising:
decoding transmission data sent a predetermined number of transmissions from respective communication partners;
identifying transmission data to be decoded by a decoding unit at a certain decoding timing among decoding timings that occur periodically; and
determining whether to decode the identified transmission data at the certain decoding timing, based on a number of transmissions in which the identified transmission data has been sent.
